(19) United States
(12) Patent Application Publication
(10) Pub. No.: US 2026/0070447 A1
(43) Pub. Date: Mar. 12, 2026

(54) CHARGING SYSTEM AND METHOD FOR ELECTRICALLY CONNECTING A WORK MACHINE TO A CHARGING STATION

(71) Applicant: Caterpillar Inc., Peoria, IL (US)

(72) Inventors: Cameron David Jensen, Granger, IN (US); Aaron R. Shatters, Montgomery, IL (US)

(73) Assignee: Caterpillar Inc., Peoria, IL (US)

(21) Appl. No.: 18/828,681

(22) Filed: Sep. 9, 2024

(51) Int. Cl. B60L 53/36; B60L 53/12; B60L 53/16; B60L 53/38; E02F 9/20

(52) U.S. Cl. CPC B60L 53/36; B60L 53/12; B60L 53/16; B60L 53/38; E02F 9/2045; B60L 2200/40

(57) ABSTRACT

Coupling a work machine charging coupler with a charging unit for providing electrical power to work machine electrical systems is provided. A charging coupler is attached to the work machine, such as a bulldozer, front-end loader, skid steer, tractor, and the like. The work machine and attached charging coupler may be moved to the charging unit autonomously via an onboard vehicle automation and navigation system. Location and alignment systems, including geolocation, LIDAR/LADAR and fiducial detection, may be employed to facilitate precise mating of the charging coupler with the charging unit. After the charging coupler and the charging unit are mated, the charging station may transfer electrical power to the work machine across an electrical interface formed when the charging coupler and the charging unit are mated.

### TECHNICAL FIELD

The present disclosure generally relates to electrical charging systems. More particularly, the present disclosure relates to a charging coupler for electrically coupling a work machine with a charging station.

### BACKGROUND

Modern machines such as vehicles of various types and equipment of various types include a variety of electrical systems requiring battery power. Different types of machines require varying levels and frequencies of battery charging. For example, a machine operated by a combustion engine typically is capable of onboard battery charging, but nonetheless may require additional charging of one or more onboard systems that require more battery resources than are provided by onboard battery charging systems. Other machines that run partially or entirely from battery power, for example, hybrid machines that utilize both combustion and electrical power or fully electric machines may require partial or complete battery charging from an external charging source. In any of these cases, such machines are typically temporarily tethered to a charging system by attaching an external charging system to the machine via a charging cord or conduit that connects the external charging system to the machine by plugging or otherwise attaching the charging cord or conduit into or to the machine for a period of time required for charging the batteries of the machine to a desired level.

In the case of large or massive equipment systems, such as material or earthmoving work machines, it is often desirable to bring a remote charging station to a work site for charging batteries of such equipment systems because the ability to charge the systems away from the work site is limited, overly cumbersome, or expensive. In addition, given the size and mass of such equipment systems, maneuvering them to a charging station and connecting them to a remote charging system can be difficult, and often coupling of the equipment systems with a charging station can cause damage to the charging station.

An example system for blocking movement of a commercial vehicle when the commercial vehicle is coupled to a building coupling part is described in German Patent No. DE102005038511B3 to Arnold Verladesysteme titled “Blocking Device for Commercial Vehicle” (hereafter “the '511 document”). In particular, the '511 document describes coupling a commercial vehicle trailer hitch permanently mounted on a building loading ramp to a corresponding vehicle coupling part to hold the vehicle during loading, unloading and/or electrical charging.

Although the systems of the '511 document describe coupling a commercial vehicle to a building during loading, unloading and/or charging, the '511 document does not describe coupling a work machine to a charging station such that electrical power may be transferred across an interface between a coupling between the work machine and the charging station. In addition, the '511document does not describe that the coupling of the work machine and the charging station may be performed automatically by automated movement of the work machine into position followed by automatic coupling of the work machine charging coupler with a fixed or remote charging station. Moreover, the systems of the '511 document do not provide for automatically coupling a work machine with a charging station by aligning a work machine charging coupler with a charging unit via one or more automated location systems such as geolocation systems, distance-to-object systems, and the like.

Examples of the present disclosure are directed to overcoming the deficiencies described above.

### SUMMARY OF THE INVENTION

Systems and methods are provided for coupling a work machine charging coupler with a charging unit for providing electrical power to work machine electrical systems, including for charging work machine batteries. A charging coupler is attached to the work machine, such as a bulldozer, front-end loader, skid steer, tractor, and the like. The charging coupler may serve as both a charging device and as a coupler for attaching work tools to the work machine. When electrical systems of the work machine, for example, onboard batteries, require charging, the work machine with attached charging coupler may be moved toward a charging station that is fixed to a facility or remote (i.e., moveable to various locations for charging purposes) at which the charging coupler is mated to a charging station charging unit (hereafter “charging unit”). The work machine and attached charging coupler may be moved to the charging unit autonomously via an onboard vehicle automation and navigation system. Location and alignment systems, including geolocation, LIDAR/LADAR and fiducial detection, may be employed to facilitate precise mating of the charging coupler with the charging unit. After the charging coupler and the charging unit are mated, the charging station may transfer electrical power across an electrical interface formed when the charging coupler and the charging unit are mated.

According to an example, a system is provided including a work machine having a chargeable battery system and a charging coupler in electrical communication with the chargeable battery system. The work machine is configured to autonomously drive to a charging unit. The work machine is further configured to autonomously couple the charging coupler with the charging unit. The charging coupler configured to receive an electrical charge transfer from the charging unit. The chargeable battery system configured for receiving the electrical charge transfer via the charging coupler.

The work machine is configured to autonomously drive to the charging unit based at least in part on geolocation information. The work machine is further configured to autonomously drive to the charging unit based at least in part on distance-to-object information. The distance-to-object information is received via a charging coupler light detection and ranging (LIDAR) emitter operative to determine a distance from the charging coupler to the charging unit.

According to another example, a method of charging a work machine is provided. The method includes attaching a charging coupler to the work machine, the charging coupler being in electrical communication with a work machine chargeable battery system. The work machine is driven to a charging station. The charging station has a charging unit that is electrically tethered to the charging station. The charging coupler is coupled to the charging unit. An electrical interface is established between the charging coupler and the charging unit. Electrical charge is transferred from the charging unit to the work machine chargeable battery system via the electrical interface between the charging coupler and the charging unit.

According to another example, a system is provided including a charging station having a charging unit coupler operative to attach to a work machine for providing electrical charge to a work machine electrical system. The work machine has a charging coupler operative to mate with the charging unit coupler for establishing an electrical interface between the charging unit coupler and the charging coupler. The work machine is configured to autonomously drive to the charging station. The work machine is further configured to autonomously mate the charging coupler with the charging unit coupler. The charging station is configured to transfer electrical charge to the work machine electrical system via the electrical interface when the charging coupler is mated with the charging unit coupler.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a right-side elevation view of a work machine with an attached work tool, according to examples of the present disclosure.

FIG. 2 illustrates the work machine of FIG. 1 showing the work tool detached from a work tool coupler, according to examples of the present disclosure.

FIG. 3 illustrates two right-side elevation views of a charging coupler partially coupled and then fully coupled with a work tool, according to examples of the present disclosure.

FIG. 4 illustrates a partial right-side elevation view of the work machine of FIG. 1 with an attached charging coupler moving toward a charging station at which the charging coupler may be coupled with a charging unit, according to examples of the present disclosure.

FIG. 5 illustrates a right-side elevation view of the work machine of FIG. 4 showing an attached charging coupler coupled with a charging unit, according to examples of the present disclosure.

FIG. 6 illustrates a front elevation view of the work machine of FIG. 1 showing a front elevation view of a work tool, according to examples of the present disclosure.

FIG. 7 illustrates a front elevation view of the work machine of FIGS. 1 and 6 showing a front elevation view of a charging coupler, according to examples of the present disclosure.

FIG. 8 illustrates two right-side elevation views of a charging coupler approaching a charging unit, according to examples of the present disclosure.

FIG. 9 illustrates a right-side elevation view of an alternative example of a charging coupler approaching an alternative example of a charging unit, according to examples of the present disclosure.

FIG. 10 illustrates a flow diagram of an example method for coupling a charging coupler of a work machine to a charging unit for charging one or more electrical systems of the work machine, according to examples of the present disclosure.

FIG. 11 illustrates a computer architecture diagram showing illustrative computer hardware architecture for implementing aspects of various technologies according to the present disclosure.

### DETAILED DESCRIPTION

Wherever possible, the same reference numbers will be used throughout the drawings to refer to the same or like parts. In the figures, the left-most digit(s) of a reference number identifies the figure in which the reference number first appears.

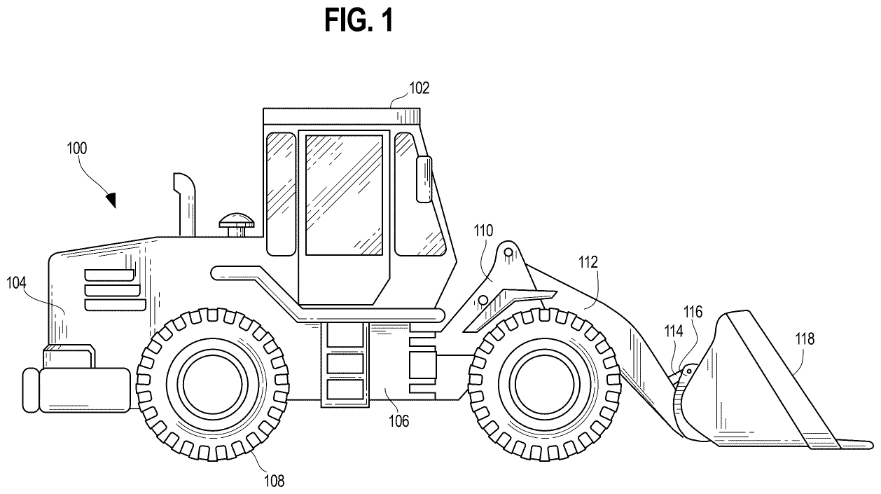

FIG. 1 illustrates a right-side elevation view of a work machine with an attached work tool according to examples of the present disclosure. As illustrated in FIG. 1, a work machine 100 is provided with which various types of work, for example, earthmoving, material moving, and the like is performed. The work machine 100 illustrates a typical front-end loader with which material such as dirt, rock, concrete, wood, steel, and the like may be moved from one location to another or may be loaded onto or unloaded from a transport, such as a truck or trailer.

The work machine 100, illustrated in FIG. 1, is for purposes of example only and is not limiting of other types of work machines that may be utilized according to examples of the present disclosure. For example, the work machine 100 may include a bulldozer, skid steer, tractor, large-scale earthmoving machine, and the like. In addition, as will be appreciated, examples of the present disclosure may be utilized with other types of vehicles, including but not limited to automobiles, trucks, trailers, and the like.

Referring still to FIG. 1, the work machine 100 includes a cab 102 in which an operator controls the work machine 100. The engine compartment 104 includes space for a combustion engine, hybrid combustion/electric engine/motor combination, or an electric motor system for a fully electric work machine 100. An under-cab section 106 is provided in which various systems such as transmissions, cabin cooling systems, and the like may be maintained. As will be described below, the under-cab section 106 also may include various control systems and battery systems available for operation of the work machine 100.

Wheel and tire assemblies 108 are provided for moving the work machine 100. As should be appreciated, other types of movement systems such as track systems also may be used for moving the work machine 100.

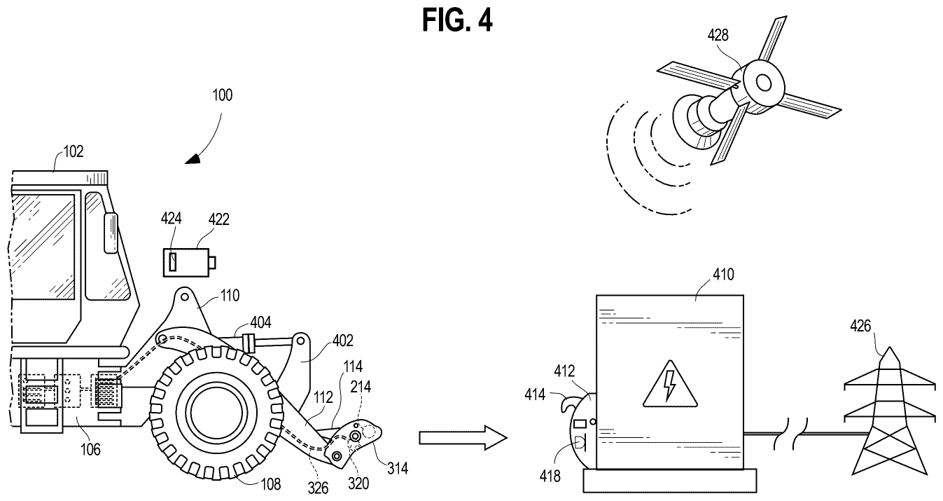

Forward of the cab 102 are components required for movement and use of a work tool attached to the work machine 100. Push arm mounts 110 are provided to which are attached one or more push arms 112. According to examples, the push arms 112 may articulate relative to the push arm mounts to raise or lower an attached work tool as required for picking up, dropping and/or pushing material. According to examples, the push arms 112 may articulate relative to the push arm mounts 110 via a suitable motion system, such as a hydraulic or pneumatic cylinder system. An alternate system for articulating the push arms 112 is illustrated and described below with reference to FIG. 4.

At a forward end of the push arms 112, a work tool coupler 116 is provided for attaching a work tool 118 to the push arms 112. A control arm 114 is illustrated for articulating the work tool coupler 116 up and down for changing the attack angle of the work tool 118. The control arm 114 may be moved by a suitable motion system, such as a hydraulic or pneumatic cylinder system.

According to examples, the work tool 118 is illustrative of a number of different work tools that may be attached to the work machine 100 via the work tool coupler 116. For example, the work tool 118 illustrated in FIG. 1 is a bucket with which material may be pushed, scooped, lifted, dumped, and the like. Other types of work tools 118 may include blades for pushing material, forks for lifting material such as pallets, and the like. Different types of work tools 118 that may be utilized with the work machine 100 are well known to those skilled in the art. As should be appreciated, the configuration of components of the work machine 100, illustrated in FIG. 1, is for purposes of illustration an example only. That is, according to other types and sizes of work machines 100, the engine compartment may be forward of the cab, work tools may be attached to a rear push arm or lifting arm, and the like.

Referring still to FIG. 1, as described above, a work tool coupler 116 is provided for attaching a work tool 118 to the push arms 112. According to examples, the work tool coupler 116 is illustrative of a number of different shapes and/or sizes of coupling devices that may be affixed to the forward ends of the push arms 112 for attaching work tools 118 of different types and sizes. According to examples, in addition to providing a mechanical interface between the push arms 112 and the work tool 118, the work tool coupler 116 provides for quick attachment and detachment of work tools 118 to the work machine 100. In some instances, the work tool coupler 116 may be designed to fit specific work tools 118. In this case, a work tool coupler 116 must be removed and replaced with another work tool coupler 116 for attaching a different work tool 118 to the work machine 100. In other instances, the work tool coupler 116 may be designed as a universal coupler that can be used for attaching a number of different types and sizes of work tools.

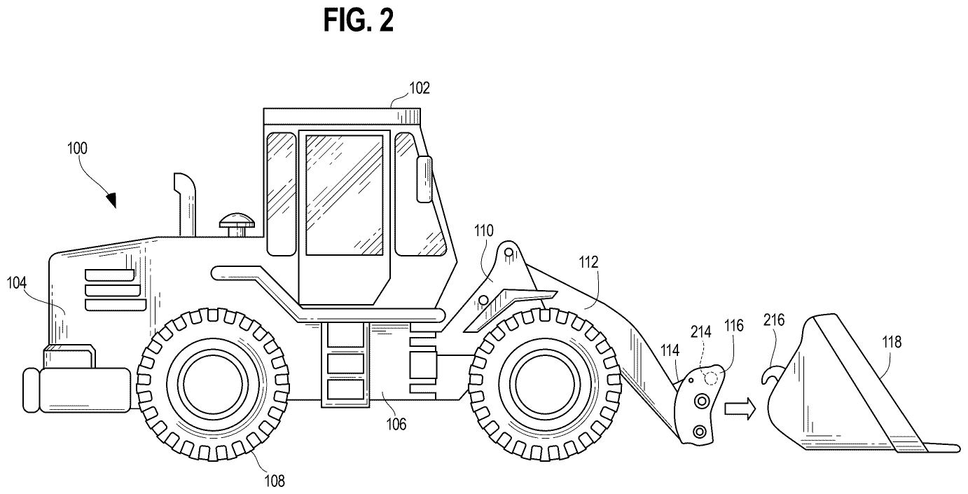

FIG. 2 illustrates the work machine of FIG. 1 showing the work tool detached from a work tool coupler, according to examples of the present disclosure. As illustrated in FIG. 2, the work tool 118 is detached from the work tool coupler 116 to allow the work tool coupler 116 to be attached to a different work tool 118. Referring to the work tool coupler 116, a side phantom view of a work tool coupler rod 214 is illustrated. When the work tool coupler 116 is attached to a work tool 118, an upper end of the work tool coupler 116 is rotated forward and down. The work machine 100 is moved forward toward the work tool 118 until the work tool coupler 116 contacts a backside of the work tool 118. The work tool coupler 116 is then rotated upward until the work tool coupler rod 214 catches underneath the work tool coupling hook 216. The lower end of the work tool coupler 116 is then rotated inward until the work tool coupler 116 fully engages the backside of the work tool 118 and the bottom of the work tool coupler latches or otherwise connects with the work tool 118. As should be appreciated, the components of the work tool coupler 116 and attachment of the work tool coupler 116 to the work tool 118, as illustrated and described herein, are for purposes of example only and are not limiting of a number of other configurations and connection mechanisms that may be used to attach the work tool coupler 116 to the work tool 118.

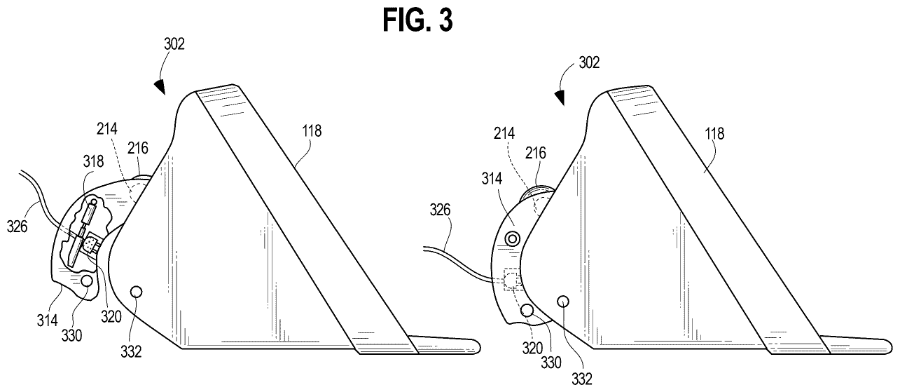

FIG. 3 illustrates a two right-side elevation views of a charging coupler partially and fully coupled with a work tool, according to examples of the present disclosure. According to examples of the present disclosure, the work tool coupler 116 may be replaced with a charging coupler 314 that may be used to attached work tools 118 to the work machine 100 and/or to mate to a charging unit for charging electrical systems of the work machine 100. That is, according to examples, the charging coupler 314 may be used in place of the work tool coupler 116 to attach a work tool 118 just for the purpose of attaching the work tool 118 to the work machine 100, or the charging coupler 314 may be used for mating to a charging unit for charging purposes. Alternatively, the charging coupler may be used for both attaching a work tool 118 to the work machine 100 and for mating to a charging unit for charging electrical systems of the work machine 100.

In the drawing 302 on the left side of FIG. 3, the charging coupler 314 is illustrated partially connected to the work tool 118. According to this example configuration, the charging coupler 314 is being attached to the work tool 118 for purposes of using the work tool 118 for moving material. Referring to the charging coupler 314, an upper end of the charging coupler 314 is hooked underneath the work tool coupler hook 216 in the same manner as described above for the work tool coupler 116 illustrated in FIG. 2.

In the drawing 304 on the right side of FIG. 3, after the upper end of the charging coupler 314 is hooked under the work tool coupling hook 216 by engaging the work tool coupler rod 214 under the work tool coupling hook 216, the bottom end of the charging coupler 314 is rotated forward until it engages the back surface of the work tool 118. According to one example, the charging coupler 314 is affixed to the work tool 118 by inserting (manually or automatically) a pin (not illustrated) through the pin orifice 330 of the charging coupler 314 and through the work tool pin orifice 332. As described above for the work tool coupler 116, the illustrated mechanism for attaching the charging coupler 314 to the work tool 118 is for purposes of example and is not limiting of other mechanisms by which the charging coupler may be attached to the work tool 118.

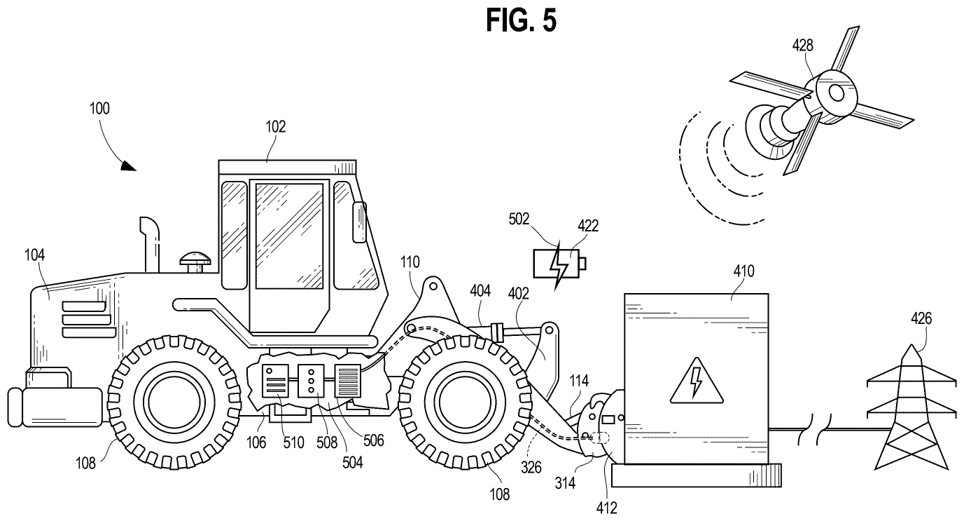

Referring still to drawing 302 on the left side of FIG. 3, the charging coupler 314 may include a rotation mechanism 318 for rotating the charging coupler 314 into and out of attachment position relative to the work tool 118 and relative to a charging unit as described below with reference to FIGS. 4 and 5. According to examples, the rotation mechanism 318 may include a hydraulic or pneumatic cylinder mechanism that moves the charging coupler 314 for attachment as illustrated in FIGS. 3, 4, and 5.

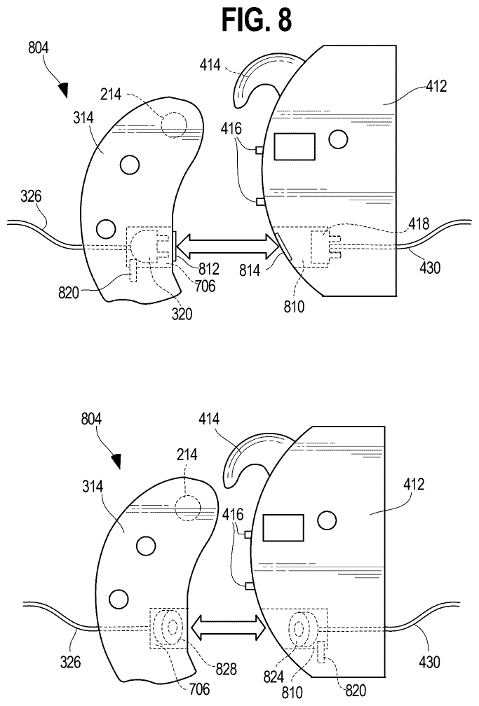

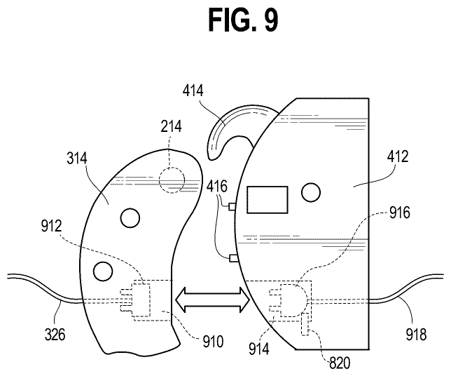

According to examples, the charging coupler 314 includes a charging adapter 320 connected to a charging cord or conduit 326. As briefly described above and as illustrated and described below with reference to FIGS. 8 and 9, when the charging coupler 314 is attached to a charging unit, the charging adapter 320 may be deployed to mate with a corresponding charging adapter receiver in the charging unit for charging electrical systems of the work machine 100. However, when the charging coupler 314 is attached to a work tool 118, as illustrated in FIG. 3, the charging adapter may remain recessed inside the charging coupler 314 to prevent damage to the charging adapter 320 from contact with the back surface of the work tool 118.

FIG. 4 illustrates a partial right-side elevation view of the work machine of FIG. 1 with an attached charging coupler moving toward a charging station at which the charging coupler may be coupled with a charging unit, according to examples of the present disclosure. As illustrated in FIG. 4, the work machine 100 has an attached charging coupler 314 and is approaching a charging station 410. Referring to the work machine 100, additional mechanical components are illustrated for articulation of the push arms 112. A push arm elevation member 402 is provided for assisting lifting of the work tool 118 by the push arms 112. A push arm elevation mechanism (e.g., a hydraulic or pneumatic system) 404 is illustrated for moving the push arm elevation member 402. As should be appreciated, the combination of the push arm elevation member 402 and the push arm elevation mechanism 404 is particularly useful in lifting the push arms 112 and work tool 118 in heavy loading situations.

Referring still to FIG. 4, the charging adapter 320 is illustrated in a recessed configuration in the charging coupler 314. The charging cord or conduit 326 is illustrated in phantom extending from the charging coupler 314 through the interior of the push arm 112, push arm mount 110 and into the under-cab section 106 where it is connected to electrical control systems, described below with reference to FIG. 5.

A battery indicator 422 with a battery charge availability indicator 424 is illustrated. According to examples, the battery indicator 422 may be displayed inside the cab 102 to alert an operator of available battery charge and for the possible need to charge the battery system of the work machine 100.

Referring still to FIG. 4, the charging station 410 is illustrative of a charging station (fixed or remote) that may be used to charge an electrical system of the work machine 100 as described herein. A charging station 410 may be affixed to a building or other structure and may be used to charge electrical systems of the work machine 100 on demand as described herein. A charging station 410 may be delivered to a work site or other location on a truck, trailer or other transport system for charging electrical systems of work machines 100 at the work site or other location.

An electrical grid 426 is illustrative of electrical power that may be connected to a charging station 410 for transferring electrical power to the electrical system, including battery charging of a work machine 100. In the case of a charging station 410 that is remote, the electrical grid 426 may charge onboard batteries in the charging station 410 that may be used for transferring electrical power to electrical systems, including battery charging systems, of the work machine 100 as described herein.

Referring still to the charging station 410, a charging unit 412 is provided for mating with the charging coupler 314 of the work machine 100. According to examples, the charging unit 412 is electrically tethered to the charging station 410 to provide electrical power from the charging station 410 through the charging unit 412 and ultimately to the work machine 100 as described herein. The charging unit 412 includes a charging unit coupling hook 414 for engaging a work tool connector rod 214 for mating the charging coupler 314 to the charging unit 412 in the same manner as attachment of the charging coupler 314 to a work tool 118 as described above with reference to FIG. 3, recessed charging adapter receiver 418 is provided for connecting to a corresponding charging adapter 320 of the charging coupler 314.

Referring still to FIG. 4, a global positioning satellite system (GPS) 428 is illustrated for providing geolocation information to the work machine 100 for enabling the work machine 100 to move to and mate with the charging station as described herein. As described below with reference to FIG. 5, a number of mechanisms may be provided for precisely maneuvering the work machine 100 into a position to mate with the charging unit 412.

FIG. 5 illustrates a right-side elevation view of the work machine of FIG. 4 showing an attached charging coupler coupled with a charging unit, according to examples of the present disclosure. As illustrated in FIG. 5, the work machine 100 is moved to the charging station 410, and the charging coupler 314 is mated with the charging unit 412, as described in further detail below with reference to FIGS. 8 and 9. After mating of the charging coupler 314 with the charging unit 412, electrical power may be transferred from the charging unit 412 to the chargeable battery system 506 of the work machine 100 via the electrical cord or conduit 326. During charging, the battery charging indicator 502 of the battery indicator 422 may indicate to an operator of the work machine 100 that battery charging is underway.

According to examples, after the charging coupler 314 is mated with the charging unit, if the charging station 410 is a remote charging station delivered to a worksite, the work machine can lift the charging station and move the charging station to other locations around the work site, or the charging station may be placed onto a transport (e.g., a truck or trailer). That is, according to examples, the mating of the charging coupler with the charging unit may allow for the charging station 410 to be affixed to the work machine just like another work tool (e.g., a bucket), and the charging station may be maneuvered by the work machine as desired.

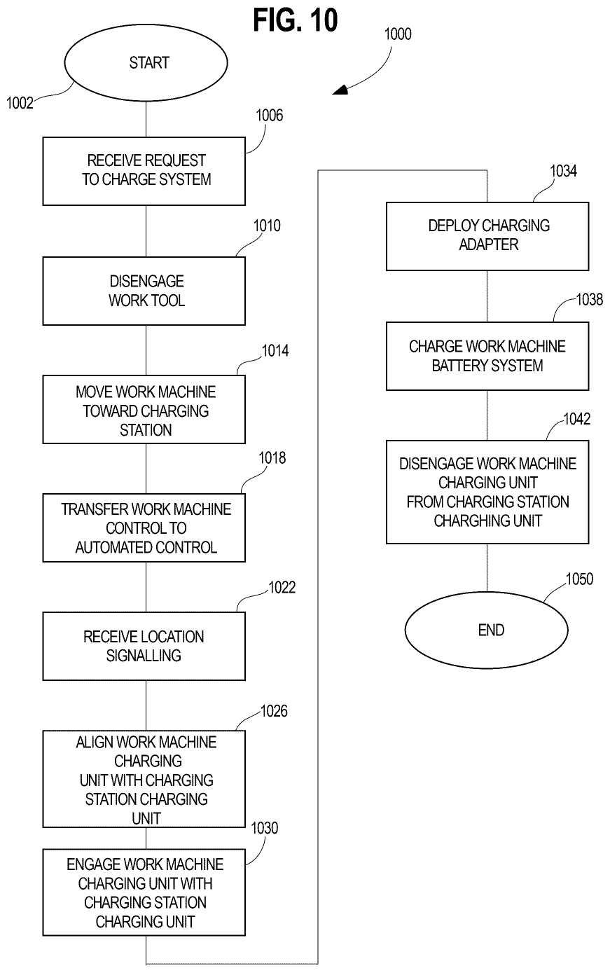

Referring still to FIG. 5, an electrical control system 504 is illustrated in a cutaway view in the under-cab section 106. According to examples, the electrical control system may include a number of components necessary for operating the work machine 100, as described herein. For example, a chargeable battery system 506 may include circuitry for receiving electrical power from the charging station and for distributing the electrical power to onboard batteries and other components of the work machine 100 requiring electrical power for operation. According to examples, the chargeable battery system 506 is in electrical communication with the charging coupler 314, as illustrated and described herein. A computer system 510 may include computing functionality, as described below with reference to FIG. 10, for directing operation of all electrically enabled systems including work machine movement automation and battery charging, as described herein.

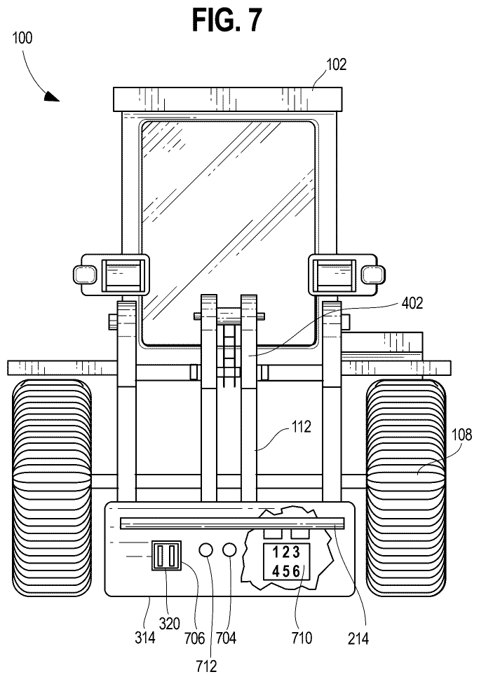

Referring still to FIG. 5, a vehicle automation and navigation system 508 may include circuitry for automating movement of the work machine 100 without driver interaction. Autonomous driving systems are well known and allow vehicles of various types, such as the work machine 100, to navigate to and autonomously drive to a desired location. As understood by those skilled in the art, an autonomous driving system, such as the vehicle automation and navigation system 508 of the present disclosure, may utilize one or more location methods and systems, such as satellite-based geolocation from one or more global positioning satellite (GPS) systems 428 that provide geolocation of the work machine 100 relative to other objects, such as the charging station 410 and charging unit 412. In addition, to such geolocation systems, additional navigation information may be received from onboard navigation systems, such as LIDAR, described below with reference to FIG. 7. In addition, further finetuning or refinement of navigation of the work machine 100 toward the charging unit 412 of the charging station 410 may be accomplished via fiducial detection, as described below with reference to FIG. 7-9.

As understood by those skilled in the art of autonomous driving systems, the vehicle automation and navigation system 508 may direct motorized control units adapted to the work machine 100 for controlling steering, throttling, and braking to autonomously drive the work machine 100. According to examples of the present disclosure, autonomously driving the work machine 100 allows the work machine 100 to autonomously drive to the charging station 410 where the charging coupler 314 may be mated with the charging unit 412, as described herein. According to one example, in addition to autonomously driving the work machine 100 to the charging station 410, the charging coupler 314 may be autonomously coupled with, attached to or mated to the charging unit 412 followed by autonomously de-coupling and/or detaching the charging coupler 314 from the charging unit 412. Autonomously coupling and de-coupling the charging coupler 314 to and from the charging unit 412 may be accomplished in the same manner as autonomously driving the work machine 100. That is, based on the aforementioned navigation information, the work machine 100 may be automatically controlled by the vehicle automation and navigation system 508 to raise, lower and otherwise manipulate the charging coupler 314 to connect the charging coupler 314 to work tools 118 and/or to the charging unit 412, as illustrated and described with reference to FIGS. 3, 4, and 5.

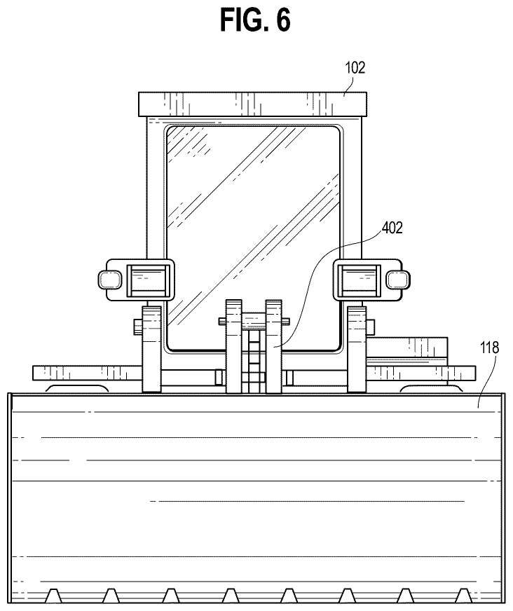

FIG. 6 illustrates a front elevation view of the work machine of FIG. 1 showing a front elevation view of a work tool, according to examples of the present disclosure. As illustrated in FIG. 6, the work tool 118 is attached to the work machine 100 as illustrated in FIG. 1. FIG. 7 illustrates a front elevation view of the work machine of FIGS. 1 and 6 showing a front elevation view of a charging coupler, according to examples of the present disclosure. As illustrated in FIG. 7, the work tool 118 has been detached, and a front face of the charging coupler 314 is exposed. Referring to the charging coupler 314, a work tool coupler rod 214 is provided for attaching the charging coupler 314 to a work tool 118 or to the charging unit 412 as illustrated in FIG. 5. The charging adapter 320 is recessed inside a recess 706 to prevent damage to the charging adapter 320 when the charging coupler 314 is mated to the charging unit 412, as described herein.

In order to align the charging coupler with a charging unit in a precise manner, in addition to systems described above for precise navigation of the charging coupler to the charging unit, one or more fiducials may be operatively affixed to a surface of the charging unit. As the advancing work machine approaches the charging unit, signaling from the charging unit fiducials may allow for very precise mating of the charging coupler with the charging unit so that electrical contact between the charging coupler and the charging unit may be brought together without damage to ensure a proper flow of electrical power transfer from the charging unit through the charging coupler attached to the work machine.

According to examples, the charging coupler 314 may also include a fiducial detector 712 for reading one or more fiducials 416 on the face of the charging unit 412 as illustrated in FIGS. 8 and 9. According to examples, the fiducials 416 on the face of the charging unit 412 may be detected by the fiducial detector 712 to precisely locate the face of the charging unit 412 for mating the charging coupler 314 to the charging unit 412. As understood by those skilled in the art, fiducials may include small attached, etched, or deposited devices that may be located via a fiducial detector for precise location of an article or device to which the fiducials are included. According to examples of the present disclosure, the fiducial detector 712 may project an energy stream, for example light, at the charging unit 412, and reflection back to the fiducial detector 712 allows for a precise locating of the fiducials and the article or device (in this case, the charging unit 412) to which the fiducials are provided. Signaling from the fiducial detector 712 may be passed to the vehicle automation and navigation system 508 via the electrical power cord or conduit 326 or wirelessly for informing automated movement of the work machine 100 for automatically mating the charging coupler 314 to the charging unit 412.

Referring still to FIG. 7, a distance-to-object emitter 704, for example, a LIDAR or LADAR emitter 704 is provided for measuring the distance of the face of the charging coupler 314 to the face of the charging unit 412. As should be appreciated, LIDAR (light detection and ranging) and LADAR (light detection and ranging) include pulsed laser streams from an emitter to an object used for measuring ranges between objects. The distance-to-object emitter 704 may also measure the speed of the work machine 100 relative to the charging station. Signaling from the distance-to-object emitter 704 may be passed to the vehicle automation and navigation system 508 via electrical power cord or conduit 326 or wirelessly for informing automated movement of the work machine 100 for automatically mating the charging coupler 314 to the charging unit 412. According to one example, knowing distance to the charging unit and the speed of the work machine 100 with the attached charging coupler 314 as it approaches the charging unit 412 may allow the vehicle automation and navigation system to slow movement of the work machine 100 as it approaches the charging unit 412 to prevent damage from contact of the charging coupler 314 with the charging unit 412.

Referring still to FIG. 7, a computing unit 710 may be provided in the charging coupler 314 for managing the components of the charging coupler 314 such as the fiducial detector 712 and the distance-to-object emitter 704. Alternatively, management of the components may be performed by the computing system 510 in the under-cab section 106, illustrated in FIG. 4.

FIG. 8 illustrates two right-side elevation views of a charging coupler approaching a charging unit, according to examples of the present disclosure. As illustrated in the top drawing 802 of FIG. 8, the charging adapter 320 is recessed in a recess 706 of the charging coupler 314 for connecting to the charging adapter receiver 418 recessed in the charging unit 412. In this state, the charging coupler 314 can be mated with the charging unit 412, as described in connection with FIGS. 3-5. After, or during, the charging coupler 314 mating with the charging unit 412, the charging adapter 320 may be automatically moved out of the recess 706 and may be electrically connected to the charging adapter receiver 418. In this way, the mechanical mating process that involves movement and/or articulation (e.g., multi-axis movement) of the work machine 100 and/or the work tool coupler 116, or charging coupler 314, is separated from the electrical connection process to protect sensitive electrical components that could be damaged with imprecise movements. The electrical components can be protected either by moving the charging adapter 320 out of the recess 706 (as described in this section) or by rotating the charging coupler 314 about a fixed point of contact with the charging unit 412 (as shown with respect to the work tool coupling hook 216 in FIG. 3).

According to examples, the charging adapter 320 is moved out of the recess by an actuator 820 that moves the charging adapter out of the recess 706 and into electrical connection with the charging adapter receiver 418. The adapter receiver 418 may be similarly automatically moved in and out of a recess 810. Alternatively, instead of connecting the charging adapter 320 to the charging adapter receiver 418, a charging coupler electrical contact 812 may make electrical contact with a charging unit electrical contact 814 for electrically connecting the charging coupler 314 with the charging unit 412. According to examples, when the charging coupler 314 and the charging unit 412 are mated, an electrical interface between the charging coupler 314 and the charging unit 412 is established. An electrical power cord or conduit 430 is provided for electrical contact from the charging unit 412 to one or more systems (e.g., batteries) in the charging station 410. After the charging coupler 314 and the charging unit 412 are electrically connected, electrical power from the charging station may transfer from the charging station to the electrical systems (e.g., battery(ies)) of the work machine 100. That is, the transfer of electrical power is performed via the connection of the charging adapter 320 with the charging adapter receiver 418 as described above.

Referring now to the bottom drawing 804 of FIG. 8, according to an alternative example, instead of forming an electrical interface by connecting the charging adapter 320 to the charging adapter receiver 418 or via the charging coupler electrical contact 812 to the charging unit electrical contact 814, an electrical induction transmitter coil (hereafter “transmitter coil”) 824 is provided or disposed in the charging unit 412 for providing induction transfer of electrical charge to a corresponding electrical induction receiver coil (hereafter “receiver coil”) 828 provided or disposed in the charging coupler 314. According to examples, the transmitter coil 824 may be maintained in the recess 810, and the receiver coil 828 may be maintained in the recess 706 until the charging coupler 314 is mated to the charging unit 412 to protect the transmitter coil and the receiver coil from damage during the mating process. After the charging coupler 314 is mated to the charging unit 412, an actuator 820 may move the transmitter coil 824 out of the recess 810 until it contacts or comes into close proximity with the receiver coil to form an induction field between the transmitter coil 824 and the receiver coil 828.

According to this example, the transfer of electrical power is performed by induction where the transmitter coil 824 forms an induction field with the corresponding receiver coil 828. As understood by those skilled in the art, electrical charge may be transferred across the induction field formed between the transmitter coil 824 and the receiver coil 828 when electrical power is supplied to the transmitter coil 824 from the charging station 410. That is, supplying electrical charge to the transmitter coil 824 generates an electrical field about the transmitter coil. When the transmitter coil 824 is brought into contact with the receiver coil 828 either by physical contact or by a close distance between the transmitter coil and the receiver coil, electrical charge may pass between the transmitter coil and the receiver coil by induction. Electrical charge passed via the electrical interface formed between the transmitter coil and the receiver coil may then be passed to electrical systems of the work machine 100 as described herein.

FIG. 9 illustrates a right-side elevation view of an alternative example of a charging coupler approaching and an alternative example of a charging unit, according to examples of the present disclosure. As illustrated in FIG. 9, the charging adapter 916 is positioned in a recess 914 of the charging unit 412. The charging adapter receiver 912 is positioned in a recess 910 of the charging coupler 314 in an opposite configuration as illustrated for the charging adapter and charging adapter receiver in FIG. 8. According to examples, when the charging coupler 314 and the charging unit 412 are mated, an electrical interface between the charging coupler 314 and the charging unit 412 is established. After the charging coupler 314 and the charging unit 412 are electrically connected, electrical power from the charging station may transfer from the charging station to the electrical systems (e.g., battery(ies)) of the work machine 100. That is, the transfer of electrical power is performed via the connection of the charging adapter 916 with the charging adapter receiver 912, as described above.

FIG. 10 illustrates a flow diagram of an example method for coupling a charging coupler of a work machine to a charging unit for charging one or more electrical systems of the work machine, according to examples of the present disclosure. The method 1000 begins at start operation 1002 and proceeds to operation 1006 where a request to charge the electrical systems, including battery systems, of a work machine 100 is received. As should be appreciated, the request to charge the electrical systems of the work machine 100 may be initiated by an operator based on an indication on the battery indicator 422 that the batteries of the work machine 100 require charging.

At operation 1010, any work tool 118 presently attached to a work tool coupler 116 is disengaged and detached from the work machine 100, as described above. At operation 1010, if the work tool coupler 116 is presently engaged or attached to the work machine 100, the work tool coupler 116 is replaced with a charging coupler 314, as described above.

At operation 1014, the work machine 100 is moved toward the charging station 410. As should be appreciated, at operation 1014, movement of the work machine 100 toward the charging station 410 may be initially performed manually by an operator of the work machine 100. At operation 1018, navigation and movement of the work machine 100 may be transferred to automatic control via the vehicle automation and navigation system 508, and the work machine 100 is then operated toward the charging station 410 via driverless control. Alternatively, if the work machine is to be driven to and attached to the charging station 410 by user control, the user may manually drive the work machine to the charging station based on navigation information as described below.

At operation 1022, location signaling from a global positioning satellite system 428, a distance-to-object emitter 704 and/or the fiducial detector 612 is received at the vehicle automation and navigation system 508. At operation 1026, according to one example, the fiducial detector 712 reads signaling returns from the fiducials 416 disposed on the surface of the charging unit 412 for precisely aligning the charging coupler 314 with a charging unit 412.

At operation 1030, the charging coupler 314 attached to the work machine 100 is engaged with the charging unit 412, as illustrated above with reference to FIG. 5. At operation 1034, the charging adapter is deployed from either the charging coupler 314 or from the charging unit 412 to the charging adapter receiver 418, 912 for establishing electrical contact between the charging unit 412 and the charging coupler 314. At operation 1034, alternatively, electrical connection between the charging unit 412 and the charging coupler 314 is established by contact of electrical contacts 812 of the charging coupler 314 with electrical contacts 814 of the charging unit 412.

At operation 1038, electrical power is transferred from the charging unit 412 from the charging station 410 through the charging unit 412 and across an interface established by engagement of the charging unit 412 with the charging coupler 314. Electrical charge is then passed through the charging cord or conduit 326 to the chargeable battery system 506 for distribution to electrical systems of the work machine 100, including for battery charging.

At operation 1042, after the electrical systems, including batteries of the work machine 100 are fully charged or charged to a desired level, the charging coupler 314 is disengaged from the charging unit 412 by moving the work machine 100 back away from the charging station 410 to disengage the charging coupler from the charging unit 412. The work machine 100 may then move into position to attach the charging coupler 314 or a subsequently attached work tool coupler 116 to a work tool 118 to allow the work machine 100 to return to service as desired. The method 1000 ends at operation 1050.

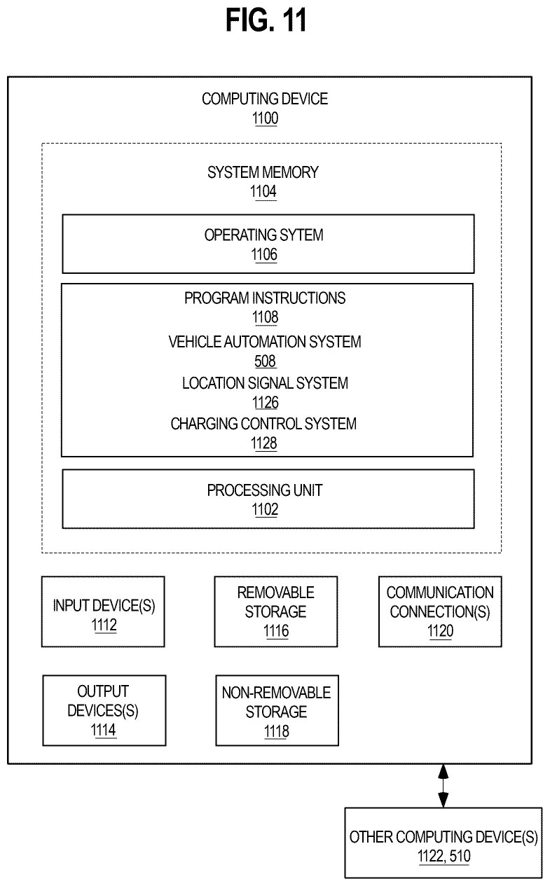

FIG. 11 is a block diagram illustrating physical components of an example computing device with which examples of the present disclosure may be practiced. The computing system 1100 may include at least one processing unit 1102 and the system memory 1104. The system memory 1104 may comprise, but is not limited to, volatile (e.g., random access memory (RAM)), non-volatile (e.g., read only memory (ROM)), flash memory, or any combination thereof. System memory 1104 may include an operating system 1106, one or more program instructions 1108, and may include sufficient computer-executable instructions for operating the vehicle automation and navigation system 508, a location signal system 1126 that receives and distributes geolocation, distance-to-object data, and fiducial location information described herein, as well as the chargeable battery system 506. Operating system 1106, for example, may be suitable for controlling the operation of the computing system 1100. Furthermore, examples may be practiced in conjunction with a graphics library, other operating systems, or other application programs and is not limited to any application or system. This basic configuration is illustrated by those components within a dashed line 1110. The computing system 1100 may also include one or more input device(s) 1112 (e.g., keyboard, mouse, pen, touch input device, etc.) and one or more output device(s) 1114 (e.g., display, speakers, printers, etc.).

The computing system 1100 may also include additional data storage devices (removable or non-removable) such as, for example, magnetic discs, optical discs, or tape. Such additional storage is illustrated by removable storage 1116 and a nonremovable storage 1118. The computing system 1100 may also contain a communication connection 1120 that may allow the computing system 1100 to communicate with other computing devices 1122 (e.g., the work machine computing system 510 and/or the charging coupler computing unit 710), such as over a network in a distributed computing environment, for example, an intranet or the Internet. The communication connection 1120 is an example of a communication medium, via which computer-readable transmission media (i.e., signals) may be propagated.

Program modules may include routines, programs, components, data structures, and other structures that may perform tasks or that may implement particular abstract data types. Moreover, examples may be practiced with other computer system configurations, including hand-held devices, multiprocessor systems, microprocessor-based or programmable user electronics, minicomputers, mainframe computers, and the like. Examples may also be practiced in distributed computing environments where tasks are performed by remote computing and processing devices that are linked through a communications network. In a distributed computing environment, programming modules may be located in both local and remote memory storage devices. Furthermore, examples may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SOC)). Examples may also be practiced using other technologies capable of performing logical operations such as, for example, AND, OR, and NOT, including but not limited to mechanical, optical, fluidic, and quantum technologies. In addition, examples may be practiced within a general-purpose computer or in other circuits or systems.

Examples may be implemented as a computer process (method), a computing system, or as an article of manufacture, such as a computer program product or computer-readable storage medium. The computer program product may be a computer storage medium readable by a computer system and encoding a computer program with instructions for executing a computer process. Accordingly, hardware or software (including firmware, resident software, micro-code, etc.) may provide examples discussed herein. Examples may take the form of a computer program product on a computer-usable or computer-readable storage medium having computer-usable or computer-readable program code embodied in the medium for use by, or in connection with, an instruction execution system.

Examples of the present disclosure may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented within the computing system 1100 or any other computing devices 1122, in combination with the computing system 1100, where functionality may be brought together over a network in a distributed computing environment, for example, an intranet or the Internet to perform the functions described herein. Systems, devices, and processors described herein are provided as examples; however, other systems, devices, and processors may comprise the memory storage and processing unit, consistent with the described disclosure.

Reference is made herein to the examples illustrated in the drawings, and specific language is used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details have been provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features, it is to be understood that the subject matter defined in the appended claims is not necessarily limited to the specific features described. Rather, the specific features are disclosed as illustrative forms of implementing the claims.

### INDUSTRIAL APPLICABILITY

Systems and methods are provided for coupling a work machine charging coupler with a charging unit attached to or part of a charging station for providing electrical power to work machine electrical systems, including for charging work machine batteries. A charging coupler is attached to the work machine, such as a bulldozer, front-end loader, skid steer, tractor, and the like. The charging coupler may replace a conventional coupler used for attaching a work tool to the work machine, such as a bucket, blade, fork, and the like, or the charging coupler may serve as both a charging device and as a coupler for attaching work tools to the work machine.

When electrical systems of the work machine, for example, onboard batteries, require charging, the work machine with attached charging coupler is moved toward a fixed or remote charging station at which the charging coupler is mated to a charging unit. The work machine and attached charging coupler may be moved to the charging unit autonomously via an onboard vehicle automation and navigation system. Systems may be employed to facilitate precise and gentle mating of the charging coupler with the charging unit. A geolocation system may be employed for precisely locating the charging unit relative to the work machine and charging coupler. Other systems may be employed, for example, a LIDAR or LADAR system for precisely measuring the distance (as well as speed of movement) between the work machine charging coupler and the charging unit. Signaling from charging unit fiducials may allow for very precise mating of the charging coupler with the charging unit so that electrical contact between the charging coupler and the charging unit may be brought together without damage to ensure a proper flow of electrical power transfer from the charging unit through the charging coupler attached to the work machine.

When the charging coupler is mated to the charging unit for charging purposes, a charging adapter may be deployed from the charging coupler to engage a charging adapter receiver in the charging unit. Instead of a charging adapter and charging adapter receiver combination, fixed electrical contacts on each of the charging coupler and the charging unit may be connected for electrical charging via an interface of the fixed electrical contacts. Alternatively, an electrical induction transmitter coil may be disposed on the charging unit, and an electrical induction receiver coil may be disposed on the charging coupler. When the charging coupler and the charging unit are mated, electrical charging may be passed from the electrical induction transmitter coil to the electrical induction receiver coil by induction.

After the charging coupler and the charging unit are thus mated, the charging station may transfer electrical power across an electrical interface formed when the charging coupler and the charging unit are mated. Transfer of electrical power to the charging coupler is routed to the electrical systems of the work machine, including work machine battery systems. Once required electrical transfer is complete, including battery systems charging, the charging coupler may be de-coupled from the charging unit to allow the work machine to be returned to service.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A system, comprising:
a work machine having a chargeable battery system and a charging coupler in electrical communication with the chargeable battery system;
the work machine configured to autonomously drive to a charging unit;
the work machine further configured to autonomously couple the charging coupler with the charging unit;
the charging coupler configured to receive an electrical charge transfer from the charging unit; and
the chargeable battery system configured for receiving the electrical charge transfer via the charging coupler.

2. The system of claim 1, wherein the work machine is configured to autonomously drive to the charging unit based at least in part on geolocation information.

3. The system of claim 2, wherein the work machine is further configured to autonomously drive to the charging unit based at least in part on distance-to-object information.

4. The system of claim 3, wherein the distance-to-object information is received via a charging coupler light detection and ranging (LIDAR) emitter operative to determine a distance from the charging coupler to the charging unit.

5. The system of claim 1, wherein the work machine is configured to autonomously couple the charging coupler with the charging unit by aligning the charging coupler with the charging unit based at least in part on locating one or more fiducials disposed on the charging unit.

6. The system of claim 5, wherein the charging coupler includes a fiducial detector configured for locating the one or more fiducials disposed on the charging unit.

7. The system of claim 1, wherein the charging coupler is configured to receive an electrical charge transfer from the charging unit via an electrical interface between the charging coupler and the charging unit.

8. The system of claim 7, wherein the electrical interface includes an electrical charging adapter deployable from the charging coupler for electrical connection with an electrical charging adapter receiver of the charging unit.

9. The system of claim 7, wherein the electrical interface includes an inductive electrical interface between an electrical receiver coil disposed on the charging coupler and an electrical transmitter coil disposed on the charging unit, where the electrical transmitter coil engages the electrical receiver coil when the charging coupler is coupled with the charging unit.

10. The system of claim 1, wherein the work machine includes a material moving vehicle.

11. A method of charging a work machine, comprising:
attaching a charging coupler to the work machine, the charging coupler being in electrical communication with a work machine chargeable battery system;
driving the work machine to a charging station, the charging station having a charging unit, the charging unit electrically tethered to the charging station;
coupling the charging coupler to the charging unit;
establishing an electrical interface between the charging coupler and the charging unit; and
transferring electrical charge from the charging unit to the work machine chargeable battery system via the electrical interface between the charging coupler and the charging unit.

12. The method of claim 11, further comprising, after transferring electrical charge from the charging unit to the work machine chargeable battery system, de-coupling the charging coupler from the charging unit.

13. The method of claim 11, wherein driving the work machine to the charging station includes autonomously navigating the work machine to the charging station based at least in part on geolocation information.

14. The method of claim 13, wherein driving the work machine to the charging station includes autonomously navigating the work machine to the charging station based at least in part on distance-to-object information.

15. The method of claim 14, further comprising receiving the distance-to-object information via a charging coupler light detection and ranging (LIDAR) emitter operative to determine a distance from the charging coupler to the charging station.

16. The method of claim 11, wherein coupling the charging coupler to the charging unit includes aligning the charging coupler with the charging unit based at least in part on detecting one or more fiducials disposed on the charging unit.

17. The method of claim 11, wherein establishing an electrical interface between the charging coupler and the charging unit includes deploying an electrical charging adapter from the charging coupler and connecting the electrical charging adapter to an electrical charging adapter receiver of the charging unit.

18. The method of claim 11, wherein establishing an electrical interface between the charging coupler and the charging unit includes establishing an electrical charge interface between a first electrical contact disposed on the charging coupler and a second electrical contact disposed on the charging unit, and engaging the first electrical contact with the second electrical contact when the charging coupler is coupled with the charging unit.

19. A system, comprising:
a charging station having a charging unit coupler operative to attach to a work machine for providing electrical charge to a work machine electrical system;
the work machine having a charging coupler operative to mate with the charging unit coupler for establishing an electrical interface between the charging unit coupler and the charging coupler;
the work machine configured to autonomously drive to the charging station;
the work machine further configured to autonomously mate the charging coupler with the charging unit coupler; and
the charging station configured to transfer electrical charge to the work machine electrical system via the electrical interface when the charging coupler is mated with the charging unit coupler.

20. The system of claim 19, wherein the electrical interface includes an electrical charge interface between a first electrical contact disposed on the charging coupler and a second electrical contact disposed on the charging unit coupler, where the first electrical contact engages the second electrical contact when the charging coupler is autonomously mated with the charging unit coupler.
